(19) United States
(12) Patent Application Publication
(10) Pub. No.: US 2015/0071589 A1
(43) Pub. Date: Mar. 12, 2015

(54) SEMICONDUCTOR OPTICAL DEVICE AND OPTICAL MODULE

(71) Applicant: OCLARO JAPAN, INC., Kanagawa (JP)

(72) Inventors: Atsushi NAKAMURA, Komoro (JP); Kazuhiko NAOE, Yokohama (JP); Toshihiko FUKAMACHI, Yokohama (JP); Masaru MUKAIKUBO, Tokyo (JP)

(21) Appl. No.: 14/480,814

(22) Filed: Sep. 9, 2014

(30) Foreign Application Priority Data
Sep. 12, 2013 (JP) 2013-189122

(51) Int. Cl. G02B 6/34

(52) U.S. Cl. CPC G02B 6/34
USPC 385/37

(57) ABSTRACT

To suppress occurrence of axial hole burning in a phase shift portion of a diffraction grating, provided is a semiconductor optical device including: a diffraction grating layer including a diffraction grating and a phase shift portion; and an optical waveguide layer including an active layer that has a gain with respect to an emission wavelength and an optical waveguide region that has no gain with respect to the emission wavelength. The optical waveguide region is formed at least on the lower side of the phase shift portion.

### CROSS-REFERENCE TO RELATED APPLICATION

The present application claims priority from Japanese application JP 2013-189122 filed on Sep. 12, 2013, the content of which is hereby incorporated by reference into this application.

### BACKGROUND OF THE INVENTION

1. Field of the Invention

The present invention relates to a semiconductor optical device and an optical module.

2. Description of the Related Art

There is known a distributed feedback semiconductor laser including a diffraction grating having, at a phase discontinuous part thereof, a phase shift portion whose phase is shifted by one half of a period of a pattern of the diffraction grating (one fourth of an emission wavelength of a resonator) (for example, see Japanese Patent Application Laid-open Nos. Hei 05-048197, 2004-259924, 2000-68590, and 2003-152272).

In a phase shift portion of a semiconductor optical device, light may concentrate to increase the amount of carrier consumption and reduce the carrier density due to stimulated emission in the phase shift portion, which is a phenomenon called axial hole burning. This axial hole burning causes reduction of carriers, increase of a refractive index, and fluctuation of an effective pitch of the diffraction grating in the phase shift portion, and hence the side mode suppression ratio (SMSR) is reduced to increase the spectral linewidth. As described above, in the distributed feedback semiconductor laser, the axial hole burning is an obstacle to achieve high power and to achieve a high speed semiconductor laser as well because it becomes difficult to increase the light density.

The present invention has been made in view of the above-mentioned problems, and has an object to provide a semiconductor optical device and an optical module which are capable of suppressing occurrence of the axial hole burning in the phase shift portion of the diffraction grating.

### SUMMARY OF THE INVENTION

(1) A semiconductor optical device according to one embodiment of the present invention includes: a diffraction grating layer including a diffraction grating including a phase shift portion; and an optical waveguide layer including: a first semiconductor region including an active layer that has a gain with respect to an emission wavelength; and a second semiconductor region that has no gain with respect to the emission wavelength, in which the second semiconductor region is formed at least on one of a lower side and an upper side of the phase shift portion.

(2) In the semiconductor optical device according to Item (1), the phase shift portion may have a phase shift amount Δφ of Δφ=(m+1/2)×Λ, where m is an integer of 0 or more and Λ represents a period of the diffraction grating.

(3) In the semiconductor optical device according to Item (1) or (2), a distance between a center position of the phase shift portion and a connection portion between the first semiconductor region and the second semiconductor region may be 10 μm or more.

(4) In the semiconductor optical device according to any one of Items (1) to (3), the phase shift portion may be formed through one of discontinuity of the diffraction grating, variation of a pitch of the diffraction grating, variation of a stripe width, and variation of an optical waveguide film thickness.

(5) In the semiconductor optical device according to any one of Items (1) to (4), the diffraction grating may be formed from a front end to a rear end of the optical waveguide layer.

(6) In the semiconductor optical device according to any one of Items (1) to (4), the optical waveguide layer may include the second semiconductor regions and the first semiconductor region formed between the second semiconductor regions, and one of the second semiconductor regions, which is located on a rear end side of the optical waveguide layer, may be formed at least on one of the lower side and the upper side of the phase shift portion.

(7) The semiconductor optical device according to any one of Items (1) to (4) may further include a non-reflective coating film formed on a front end surface of the optical waveguide layer, and the diffraction grating may be prevented from being formed in a predetermined range from a front end of the optical waveguide layer in the diffraction grating layer.

(8) The semiconductor optical device according to any one of Items (1) to (7) may further include an electrode formed in part above the optical waveguide layer, and the electrode may be formed at least above the first semiconductor region.

(9) The semiconductor optical device according to any one of Items (1) to (7) may further include an electrode formed from a front end to a rear end of the optical waveguide layer.

(10) The semiconductor optical device according to any one of Items (1) to (7) may further include: an electrode formed from a front end to a rear end of the optical waveguide layer; and an insulating film formed between the electrode and the second semiconductor region.

(11) An optical module according to one embodiment of the present invention includes the semiconductor optical device according to any one of Items (1) to (10) mounted thereon.

According to one embodiment of the present invention, an optical waveguide having no gain with respect to the emission wavelength is formed for the phase shift portion of the diffraction grating, and thus it is possible to suppress the occurrence of the axial hole burning in the phase shift portion of the diffraction grating.

### BRIEF DESCRIPTION OF THE DRAWINGS

FIG. 1 is a sectional view of a semiconductor optical device according to a first embodiment of the present invention.

FIG. 2 is a sectional view of a semiconductor optical device according to a second embodiment of the present invention.

FIG. 3 is a sectional view of a semiconductor optical device according to a third embodiment of the present invention.

FIG. 4 is a sectional view of a semiconductor optical device according to a fourth embodiment of the present invention.

FIG. 5 is a sectional view of a semiconductor optical device according to a fifth embodiment of the present invention.

FIG. 6 is a sectional view of a semiconductor optical device according to a sixth embodiment of the present invention.

FIG. 7 is a sectional view of a semiconductor optical device according to a seventh embodiment of the present invention.

FIG. 8 is a sectional view of a semiconductor optical device according to a comparative example of the present invention.

### DETAILED DESCRIPTION OF THE INVENTION

Now, modes for carrying out the present invention (hereinafter referred to as embodiments) are described with reference to the drawings.

### DESCRIPTION OF COMPARATIVE EXAMPLE

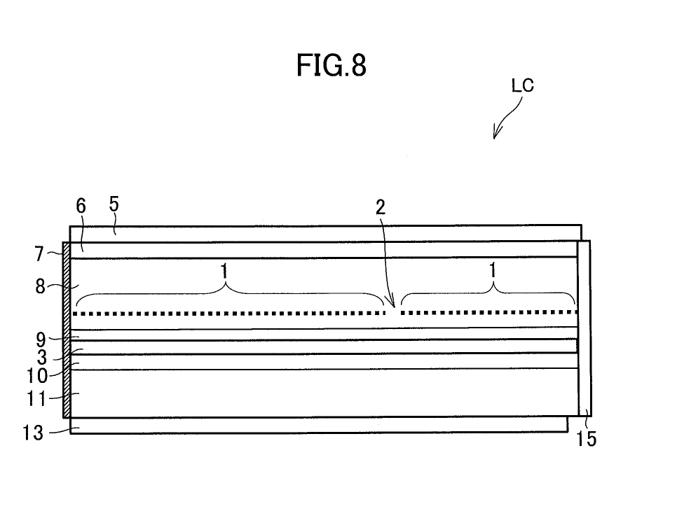

Prior to the description of the embodiments of the present invention, problems to be solved by the present invention are described with reference to a configuration of a semiconductor optical device LC (distributed feedback semiconductor laser) according to a comparative example of the present invention illustrated in FIG. 8.

FIG. 8 is a sectional view of the semiconductor optical device LC according to the comparative example. In FIG. 8, the semiconductor optical device LC includes a diffraction grating layer 1, a phase shift portion 2, an active layer 3 forming an optical waveguide, a P-side electrode 5 for energization, a P-type InGaAs contact layer 6 for reducing a resistance between the electrode and crystal, a front end surface coating film 7, a P-type InP cladding layer 8, a P-type InGaAsP guiding layer 9, an N-type InGaAsP guiding layer 10, an N-type InP cladding layer 11, an N-side electrode 13, and a rear end surface coating film 15.

As illustrated in FIG. 8, the diffraction grating layer 1 is formed over the entire active layer 3, and the phase shift portion 2 is formed in a part of the diffraction grating layer 1. The phase shift portion 2 is a discontinuous part of the diffraction grating, in which, for example, the phase of the diffraction grating is shifted by ½ with respect to a pitch Λ of the diffraction grating. This structure is called λ/4 phase shift structure.

As described above, in the semiconductor optical device LC (distributed feedback semiconductor laser) provided with the λ/4 phase shift structure, light concentrates in the phase shift portion 2. Therefore, in the semiconductor optical device LC (distributed feedback semiconductor laser) according to the comparative example illustrated in FIG. 8, the amount of carrier consumption increases and the carrier density reduces due to stimulated emission in the phase shift portion 2. Then, in the phase shift portion 2 with the reduced carrier density, the refractive index increases due to a plasma effect. The reduction in carrier density and the increase in refractive index caused by the reduction in carrier density correspond to a phenomenon called axial hole burning. The fluctuation in refractive index due to the axial hole burning is equivalent to the fluctuation in diffraction grating pitch, and hence the SMSR reduces to increase the spectral linewidth.

In contrast, a semiconductor optical device L (distributed feedback semiconductor laser) according to each of first to seventh embodiments described below has a structure that is capable of suppressing occurrence of the axial hole burning. Now, details of the respective embodiments are described.

### First Embodiment

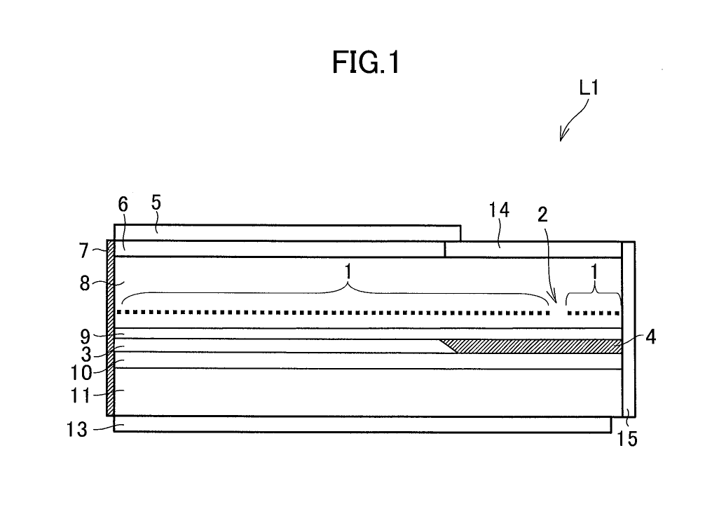

FIG. 1 is a sectional view of a semiconductor optical device L1 (distributed feedback semiconductor laser) according to the first embodiment of the present invention. In FIG. 1, the semiconductor optical device L1 includes a diffraction grating layer 1, a phase shift portion 2, an active layer 3 forming an optical waveguide, an optical waveguide region 4 with a composition that has no gain with respect to the emission wavelength of the active layer, a P-side electrode 5 for energization, a P-type InGaAs contact layer 6 for reducing a resistance between the electrode and crystal, a front end surface coating film 7, a P-type InP cladding layer 8, a P-type InGaAsP guiding layer 9, an N-type InGaAsP guiding layer 10, an N-type InP cladding layer 11, an N-side electrode 13, a SiO₂ insulating film 14, and a rear end surface coating film 15.

As illustrated in FIG. 1, in the semiconductor optical device L1 according to the first embodiment, the optical waveguide includes the active layer 3 and the optical waveguide region 4 with a composition that has no gain with respect to the emission wavelength. Further, the diffraction grating layer 1 is formed along the optical waveguide in a semiconductor layer formed above a region including the active layer 3 and the optical waveguide region 4. Further, the phase shift portion 2 of the diffraction grating layer 1 is formed in a semiconductor layer laminated above the optical waveguide region 4. The phase shift portion 2 is a discontinuous part of the diffraction grating, which has a so-called λ/4 phase shift structure in which, for example, the phase of the diffraction grating is shifted by ½ with respect to a pitch Λ of the diffraction grating.

In the semiconductor optical device L1 according to the first embodiment illustrated in FIG. 1, the phase shift portion 2 is formed above the optical waveguide region 4 that has no gain with respect to the emission wavelength. Therefore, although light concentration to the phase shift portion 2 occurs, the carrier is not consumed due to stimulated emission because the phase shift portion 2 is formed in a region that has no gain with respect to the emission wavelength. As a result, in the semiconductor optical device L1 according to the first embodiment, the occurrence of the axial hole burning can be suppressed.

Note that, in the semiconductor optical device L1 according to the first embodiment, the boundary between the active layer 3 and the optical waveguide region 4 is inclined in section. For example, the active layer 3 is subjected to wet etching so that the crystal plane orientation appears at the etching end portion, and then the optical waveguide region 4 is regrown. In this case, the connection portion between the active layer 3 and the optical waveguide region 4 is regrown as a plane orientation portion, and hence a satisfactory crystalline quality can be expected. Further, by inclining the connection part, reflection light that returns to the active layer from the connection portion can be reduced.

Further, in the semiconductor optical device L1 according to the first embodiment, when the structure is designed so that the active layer 3 and the optical waveguide region 4 have the same effective refractive index, the pitch of the diffraction grating formed in part above the active layer 3 and the pitch of the diffraction grating formed in part above the optical waveguide region 4 may be the same in a case where the active layer 3 and the optical waveguide region 4 have the same effective refractive index. In a case where the active layer 3 and the optical waveguide region 4 have different effective refractive indices, it is desired that, considering the difference of the refractive indices, the interval of the pitch of the diffraction grating formed in the part above the active layer 3 and the interval of the pitch of the diffraction grating formed in the part above the optical waveguide region 4 be designed so that the effective pitches become the same.

### Second Embodiment

Next, a semiconductor optical device L2 (distributed feedback semiconductor laser) according to the second embodiment of the present invention is described. The semiconductor optical device L2 according to the second embodiment has a characteristic suitable for high speed operation as compared to the semiconductor optical device L1 according to the first embodiment.

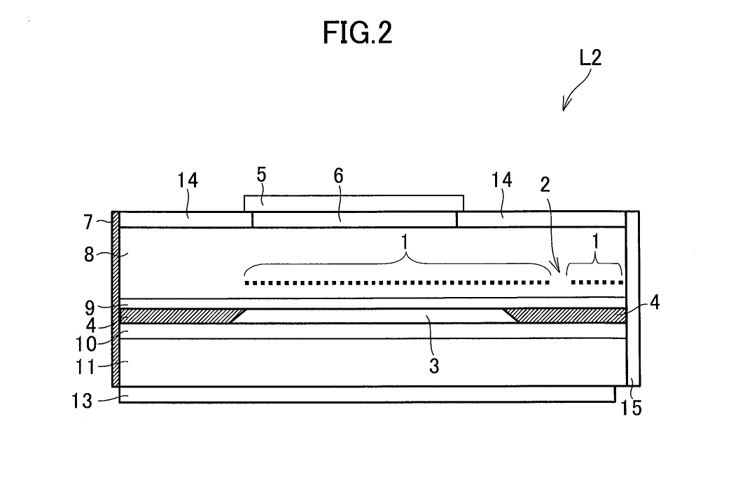

FIG. 2 is a sectional view of the semiconductor optical device L2 according to the second embodiment. Regarding the semiconductor optical device L2 of FIG. 2, description of configurations denoted by like reference symbols and parts having like functions as those illustrated in FIG. 1 described above is omitted.

First, in order to operate the distributed feedback semiconductor laser at high speed, it is necessary to increase the relaxation oscillation frequency that determines the operation band of the semiconductor laser. In order to increase the relaxation oscillation frequency, it is effective to reduce the resonator length of the semiconductor laser, but the reduction of the resonator length leads to reduction of the device size of the semiconductor laser, and hence processing such as cleavage becomes difficult. In view of this, in the second embodiment of the present invention, the optical waveguide region 4 that does not affect the effective resonator length is added also to the front side of the distributed feedback semiconductor laser.

That is, in the semiconductor optical device L2 according to the second embodiment illustrated in FIG. 2, the optical waveguide region 4 is formed not only on the rear side but also on the front side. For example, when the front end surface coating film 7 is formed as a non-reflective or low-reflective coating, light only passes through the front optical waveguide. The front optical waveguide is present outside the resonator, and hence the device size can be increased without increasing the effective resonator length. Note that, also in the semiconductor optical device L2 according to the second embodiment, the phase shift portion 2 is formed above the rear optical waveguide region 4, which has no gain with respect to the emission wavelength, and hence the occurrence of the axial hole burning can be suppressed.

Further, in the semiconductor optical device L2 according to the second embodiment, the diffraction grating is not formed for the front optical waveguide (that is, above the front optical waveguide region 4), but in a case where the emission wavelength is sufficiently separated from the stop band of the diffraction grating, the diffraction grating may be formed also for the front optical waveguide (that is, above the front optical waveguide region 4). Further, instead of forming the front end surface coating film as a non-reflective or low-reflective coating, a window structure may be employed to reduce the return light.

### Third Embodiment

Next, a semiconductor optical device L3 (distributed feedback semiconductor laser) according to the third embodiment of the present invention is described. The semiconductor optical device L3 according to the third embodiment has a characteristic more suitable for high power operation as compared to the semiconductor optical device L1 according to the first embodiment.

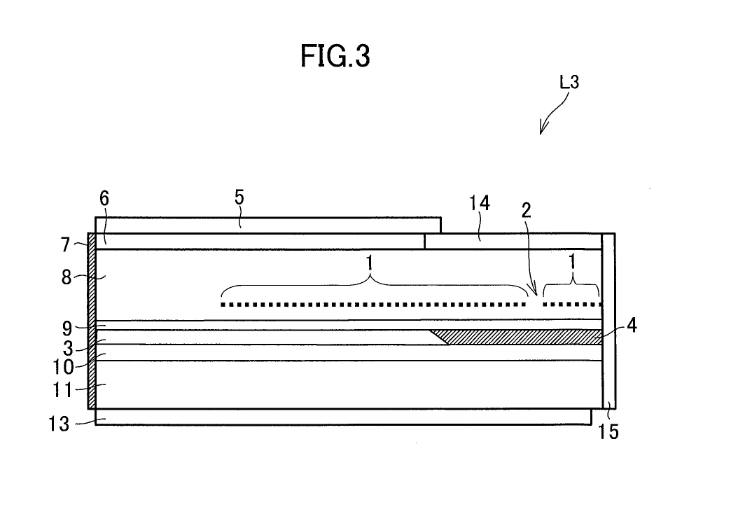

FIG. 3 is a sectional view of the semiconductor optical device L3 according to the third embodiment. Regarding the distributed feedback semiconductor laser illustrated in FIG. 3, description of configurations denoted by like reference symbols and parts having like functions as those illustrated in FIG. 1 described above is omitted. The difference from the first embodiment is described below.

The semiconductor optical device L3 according to the third embodiment illustrated in FIG. 3 differs from the semiconductor optical device L1 according to the first embodiment in that the diffraction grating layer 1 is not formed in a region above the active layer 3 in the vicinity of the front end surface (predetermined range from the front end surface). For example, when the front end surface coating film 7 is formed as a non-reflective coating film, the optical waveguide region on the front end surface side without the diffraction grating functions as an optical amplifier. As described above, the third embodiment provides a structure in which the optical amplifier is added to the structure of the first embodiment, which enables high power operation as compared to the first embodiment. Further, the third embodiment provides a structure in which the diffraction grating is absent in the front optical amplifier part, but in a case where the emission wavelength is sufficiently separated from the stop band of the diffraction grating, the diffraction grating may be formed also therefor.

### Fourth Embodiment

Next, a semiconductor optical device L4 (distributed feedback semiconductor laser) according to the fourth embodiment of the present invention is described. The semiconductor optical device L4 according to the fourth embodiment differs from the semiconductor optical device L1 of the first embodiment in that the phase shift portion 2 is realized through diffraction grating pitch modulation. Other points are the same.

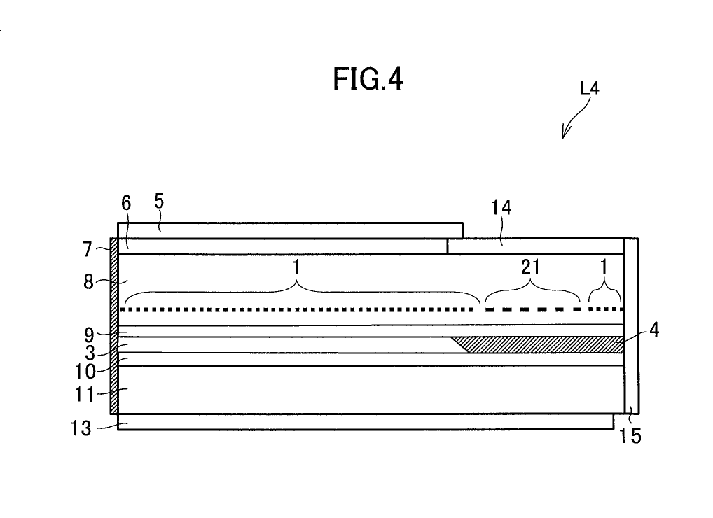

FIG. 4 is a sectional view of the semiconductor optical device L4 according to the fourth embodiment. Regarding the semiconductor optical device L4 illustrated in FIG. 4, description of configurations denoted by like reference symbols and parts having like functions as those illustrated in FIG. 1 described above is omitted.

In the semiconductor optical device L4 illustrated in FIG. 4, instead of the phase shift structure obtained through the discontinuity of the diffraction grating, a phase shift structure 21 is realized through the diffraction grating pitch modulation. Note that, also in the semiconductor optical device L4 according to the fourth embodiment, the phase shift structure 21 is formed above the rear optical waveguide region 4, which has no gain with respect to the emission wavelength, and hence the occurrence of the axial hole burning can be suppressed.

### Fifth Embodiment

Next, a semiconductor optical device L5 (distributed feedback semiconductor laser) according to the fifth embodiment of the present invention is described. The semiconductor optical device L5 according to the fifth embodiment differs from the semiconductor optical device L1 according to the first embodiment in that a plurality of phase shift portions are formed.

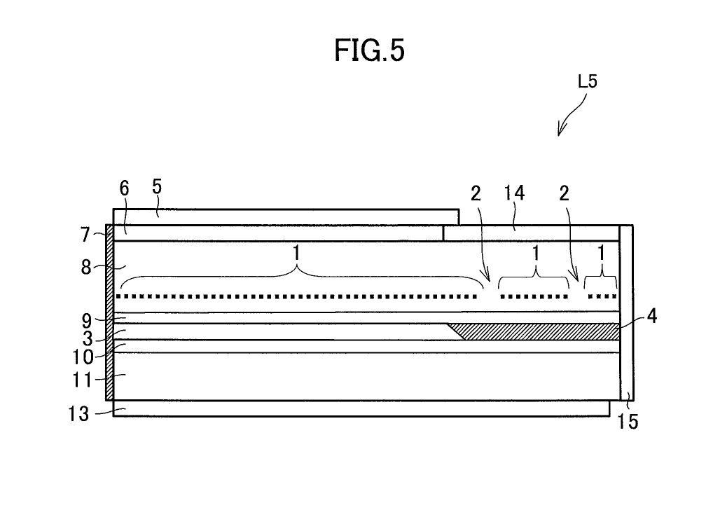

FIG. 5 is a sectional view of the semiconductor optical device L5 according to the fifth embodiment. Regarding the semiconductor optical device L5 illustrated in FIG. 5, description of configurations denoted by like reference symbols and parts having like functions as those illustrated in FIG. 1 described above is omitted.

As illustrated in FIG. 5, in the semiconductor optical device L5 according to the fifth embodiment, above the optical waveguide region 4 that has no gain with respect to the emission wavelength, the phase shift portions 2 at which the diffraction grating pitch is discontinuous are formed at two positions. With the two phase shift portions 2, the concentration of carrier consumption can be suppressed, and also the occurrence of the axial hole burning can be suppressed in each of the phase shift portions 2. Note that, in the example illustrated in FIG. 5, the phase shift portions 2 are formed at two positions, but the phase shift portions 2 may be formed at three positions or more.

### Sixth Embodiment

Next, a semiconductor optical device L6 (distributed feedback semiconductor laser) according to the sixth embodiment of the present invention is described. The semiconductor optical device L6 according to the sixth embodiment has a structure in which, as compared to the semiconductor optical device L1 according to the first embodiment, the temperature distribution in the optical waveguide axial direction becomes further uniform even when the operation current is increased.

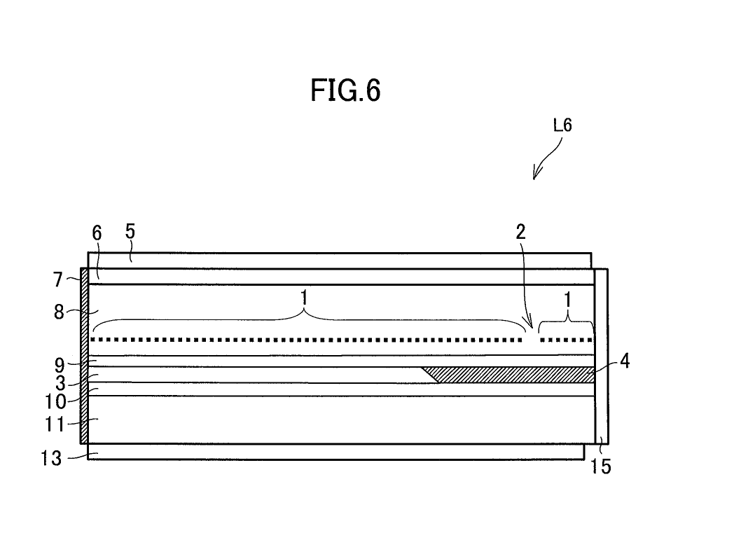

FIG. 6 is a sectional view of the semiconductor optical device L6 according to the sixth embodiment. Note that, regarding the semiconductor optical device L6 illustrated in FIG. 6, description of configurations denoted by like reference symbols and parts having like functions as those illustrated in FIG. 1 described above is omitted.

The semiconductor optical device L6 according to the sixth embodiment illustrated in FIG. 6 differs from the semiconductor optical device L1 according to the first embodiment in that the P-side electrode is formed from the front end surface to reach the rear end surface. Note that, in the semiconductor optical device L1 according to the first embodiment illustrated in FIG. 1, the electrode is formed only in a region corresponding to the active layer 3. In this case, heat is generated in the active layer 3 through energization, but no current flows through the optical waveguide region 4, and hence no heat is generated in the optical waveguide region 4. Therefore, a temperature difference is generated. Therefore, in the semiconductor optical device L1 according to the first embodiment, a difference is generated also in the amount of fluctuation in refractive index due to the temperature rise.

On the other hand, in the semiconductor optical device L6 according to the sixth embodiment, the electrode is formed from the front end surface to the rear end surface. Therefore, the active layer 3 and the optical waveguide region 4 can be simultaneously energized to reduce the temperature difference between the active layer 3 and the optical waveguide region 4. Therefore, with the semiconductor optical device L6 according to the sixth embodiment, it is possible to reduce the difference in the amount of fluctuation in refractive index due to the temperature difference between the active layer 3 and the optical waveguide region 4.

### Seventh Embodiment

Next, a semiconductor optical device L7 (distributed feedback semiconductor laser) according to the seventh embodiment of the present invention is described. The semiconductor optical device L7 according to the seventh embodiment has a structure in which, as compared to the semiconductor optical device L1 according to the first embodiment, the temperature distribution in the optical waveguide axial direction becomes further uniform even when the operation current is increased.

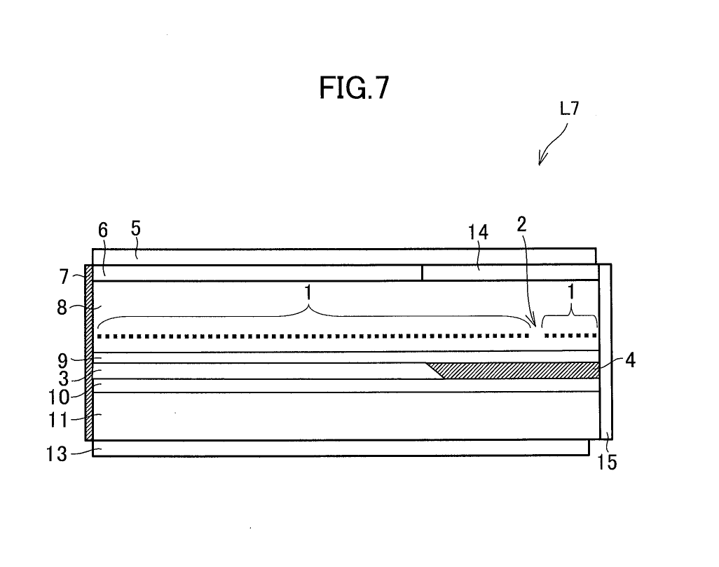

FIG. 7 is a sectional view of the semiconductor optical device L7 according to the seventh embodiment. Note that, regarding the semiconductor optical device L7 illustrated in FIG. 7, description of configurations denoted by like reference symbols and parts having like functions as those illustrated in FIG. 1 described above is omitted.

In the semiconductor optical device L6 according to the sixth embodiment illustrated in FIG. 6, the optical waveguide region 4 is energized to reduce the temperature difference with respect to the active layer 3, but the current of the optical waveguide region 4 does not contribute to the optical output, and hence the power consumption increases. On the other hand, in the semiconductor optical device L7 according to the seventh embodiment illustrated in FIG. 7, the P-side electrode 5 is formed from the front end surface to reach the rear end surface, and also a SiO₂ insulating film 14 is formed above the optical waveguide region 4. Therefore, a current does not flow through the optical waveguide region 4. A metal forming the electrode, such as Au, has a high thermal conductivity, and hence the heat of the active layer 3 can be transferred to the optical waveguide region 4. With this, in the semiconductor optical device L7 according to the seventh embodiment, the temperature difference between the active layer 3 and the optical waveguide region 4 can be reduced. Note that, in the semiconductor optical device L7 according to the seventh embodiment, the SiO₂ insulating film 14 is employed to suppress current injection into the optical waveguide region 4, but a similar effect may be obtained even when a high resistance layer, such as Fe-doped InP, is employed. When InP is used, the thermal conductivity thereof is higher than that of an insulating film such as SiO₂, and hence the temperature difference between the active layer 3 and the optical waveguide region 4 can be further reduced.

In the semiconductor optical devices according to the embodiments described above, the boundary between the active layer 3 and the optical waveguide region 4 may be separated away from the center position of the phase shift portion 2 (when there are a plurality of phase shift portions 2, center positions thereof) by 10 μm or more. In this case, the phase shift portion 2 may be formed on the optical waveguide region 4 side with respect to the active layer 3. Note that, the position of the phase shift portion 2 in the entire drawing region of the diffraction grating is located so that, when the front and rear regions with respect to the phase shift portion in the entire drawing region of the diffraction grating are referred to as a front diffraction grating region and a rear diffraction grating region, and (the length of the front diffraction grating region):(the length of the rear diffraction grating region) is represented by X:Y, X=7 to 9 and Y=3 to 1 (provided that X+Y=10) are established. In this manner, a high SMSR yield can be obtained.

Further, the phase shift portion 2 may be formed through discontinuity of the diffraction grating, variation of a pitch of the diffraction grating, variation of a stripe width, or variation of an optical waveguide film thickness. Note that, when the period of the diffraction grating is represented by Λ, a phase shift amount Δφ of the phase shift portion 2 may be Δφ=(m+1/2)×Λ (m is an integer of 0 or more).

Further, in the semiconductor optical devices according to the embodiments described above, the diffraction grating layer 1 is formed above the active layer 3 and the optical waveguide region 4, but even when the diffraction grating layer 1 is formed below the active layer 3 and the optical waveguide region 4, the effects of the present invention can be obtained.

The present invention is not limited to the embodiments described above. For example, in the semiconductor optical devices according to the embodiments described above, only the resonator is integrated therein as an example. However, it is needless to say that the present invention is also applicable to a semiconductor optical device having a resonator and a modulator integrated therein, and similar effects can be obtained.

Further, the semiconductor optical devices L1 to L7 according to the present invention may be mounted on an optical module for outputting an optical signal that is modulated in accordance with a transmission signal.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A semiconductor optical device, comprising:
a diffraction grating layer comprising a diffraction grating comprising a phase shift portion; and
an optical waveguide layer comprising:
a first semiconductor region comprising an active layer that has a gain with respect to an emission wavelength; and
a second semiconductor region that has no gain with respect to the emission wavelength,
wherein the second semiconductor region is formed at least on one of a lower side and an upper side of the phase shift portion.

2. The semiconductor optical device according to claim 1, wherein the phase shift portion has a phase shift amount Δφ of Δφ=(m+1/2)'Λ, where m is an integer of 0 or more and Λ represents a period of the diffraction grating.

3. The semiconductor optical device according to claim 1, wherein a distance between a center position of the phase shift portion and a connection portion between the first semiconductor region and the second semiconductor region is 10 μm or more.

4. The semiconductor optical device according to claim 1, wherein the phase shift portion is formed through one of discontinuity of the diffraction grating, variation of a pitch of the diffraction grating, variation of a stripe width, and variation of an optical waveguide film thickness.

5. The semiconductor optical device according to claim 1, wherein the diffraction grating is formed from a front end to a rear end of the optical waveguide layer.

6. The semiconductor optical device according to claim 1,
wherein the optical waveguide layer comprises the second semiconductor regions and the first semiconductor region formed between the second semiconductor regions, and
wherein one of the second semiconductor regions, which is located on a rear end side of the optical waveguide layer, is formed at least on one of the lower side and the upper side of the phase shift portion.

7. The semiconductor optical device according to claim 1, further comprising a non-reflective coating film formed on a front end surface of the optical waveguide layer,
wherein the diffraction grating is prevented from being formed in a predetermined range from a front end of the optical waveguide layer in the diffraction grating layer.

8. The semiconductor optical device according to claim 1, further comprising an electrode formed in part above the optical waveguide layer,
wherein the electrode is formed at least above the first semiconductor region.

9. The semiconductor optical device according to claim 1, further comprising an electrode formed from a front end to a rear end of the optical waveguide layer.

10. The semiconductor optical device according to claim 1, further comprising:
an electrode formed from a front end to a rear end of the optical waveguide layer; and
an insulating film formed between the electrode and the second semiconductor region.

11. An optical module, comprising a semiconductor optical device mounted thereon,
wherein the semiconductor optical device comprises:
a diffraction grating layer comprising a diffraction grating comprising a phase shift portion; and
an optical waveguide layer comprising:
a first semiconductor region comprising an active layer that has a gain with respect to an emission wavelength; and
a second semiconductor region that has no gain with respect to the emission wavelength, and
wherein the second semiconductor region is formed at least on one of a lower side and an upper side of the phase shift portion.
